(19) United States
(12) Patent Application Publication
(10) Pub. No.: US 2010/0208790 A1
(43) Pub. Date: Aug. 19, 2010

(54) Method and System for Reducing the Bit Stream and Electronic Device Thereof

(76) Inventors: Jung-Chang Kuo, Taipei City (TW); Wei-Hao Peng, Taipei City (TW); Shu-Fan Chen, Taipei-City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/626,992

(22) Filed: Nov. 30, 2009

(30) Foreign Application Priority Data
Feb. 13, 2009 (TW) 098104784

(51) Int. Cl. H04B 1/66; G06F 15/16

(52) U.S. Cl. 375/240.01; 709/219; 709/247; 375/E07.001

(57) ABSTRACT

A method for reducing the bit stream is disclosed. The method is used for transmitting multimedia data from a sender to a receiver via a network, wherein the multimedia data comprises a first GOP. The method comprises the steps of: acquiring transmission condition data; decoding the first GOP and converting it into a first color space; converting the first color space into a second color space according to the transmission condition data; and converting the second space into a second GOP according to the transmission condition data, whereby the sender can transmit the second GOP with the reduced bit stream in accordance with the transmission condition data to the receiver.

### BACKGROUND OF THE INVENTION

1. Field of the Invention

The present invention relates to a method and system for reducing the bit stream and an electronic device, especially to a method and system for reducing the bit stream and an electronic device which connect a sender and a receiver via a network in a peer-to-peer manner and acquire transmission condition data and the playing capability of the receiver, wherein the sender dynamically compresses or encodes multimedia data according to the transmission condition data and the playing capability of the receiver and transmits the multimedia to the receiver.

2. Description of the Related Art

With the rapid development digital techniques, there are various multimedia file formats of various electronic products (e.g. PDAs (Personal Digital Assistants), set-top boxes, mobile phones, or personal computers). Also, the bandwidths of networks are different. For example, ADSL (Asymmetric Digital Subscriber Line) runs at a downstream speed of up to 24 Mbps and a upstream speed of up to 3.5 Mbps; broadband CABLE runs at a downstream speed of up to 38 Mbps and a upstream speed of up to 27 Mbps; Optical Fiber runs at a downstream speed of up to 100 Mbps and a upstream speed of up to 5 Mbps; WiMAX (Worldwide Interoperability for Microwave Access) runs at a downstream speed of up to 70 Mbps and a upstream speed of up to 70 Mbps; GPRS (General Packet Radio Service) runs at a downstream speed of up to 64 Kbps and a upstream speed of up to 43 Kbps; 3G (3rd-generation) runs at a downstream speed of up to 384 Kbps; 3.5G (HSDPA, High-Speed Downlink Packet Access) runs at a downstream speed of up to 14.4 Mbps. Therefore, when a multimedia file is transmitted, asynchronism between the transmission and the reception may occur because of the different network environments between a sender and a receiver; or, because the network of the receiver is slower, a long delay may occur when the receiver receives a multimedia file.

Because the multimedia file formats of electronic devices are different (e.g. AVI, WMV, MPEG, MOV, or 3GP files), the receiver cannot play the multimedia file transmitted from the sender without transcoding.

The common way of transmission in present use is that the sender transmits a multimedia file to a server first, and the server decodes, transcodes, or compresses the multimedia file and then transmits it to the receiver. This procedure often consumes large amounts of the resources of the server and time, thus causing a burden on the server and over-consuming the upload bandwidth of the sender. When the multimedia file is a real-time image, it places a heavy burden on the server. Moreover, the multimedia file uploaded by the sender often exceeds the limitation of the playing capability of the receiver, which leads to a waste of upload network resources.

Therefore, it is advantageous to provide a more efficient method for reducing the bit stream, a system for reducing the bit stream, and an electronic device for solving problems in prior arts.

### SUMMARY OF THE INVENTION

It is a main object of the present invention to provide a method and system for reducing the bit stream and an electronic device which connect a sender and a receiver via a network in a peer-to-peer manner and acquire transmission condition data. The sender dynamically reduces the bit stream of multimedia data or encodes the multimedia data according to the transmission condition data and transmits the multimedia to the receiver.

In order to achieve the above object, the method for reducing the bit stream of the present invention is used when transmitting multimedia data from a sender to a receiver via a network, wherein the multimedia data comprises a first GOP. The method comprises the following steps: acquiring transmission condition data; decoding the first GOP and converting it to a first color space; converting the first color space into a second color space according to the transmission condition data; and converting the second color space into a second GOP according to the transmission condition data, whereby the sender can transmit the second GOP with the reduced bit stream in accordance with the transmission condition data to the receiver.

In one embodiment of the present invention, the method for reducing the bit stream of the present invention further comprises the following step following the step of decoding the first GOP and converting it into a first color space: converting the first color space into the second color space according to the algorithm and the transmission condition data.

In one embodiment of the present invention, the method for reducing the bit stream of the present invention further comprises the following step prior to the step of acquiring the transmission condition data: establishing a channel. The channel connects the sender and the receiver in a peer-to-peer manner so that transmission condition data can be acquired.

In order to achieve the above object, the system for reducing the bit stream of the present invention is used for transmitting multimedia data. The multimedia data is transmitted from a sender to a receiver via a network. The multimedia data comprises a first GOP, and the first GOP comprises a plurality of frames. The system comprises a detection module, a decoding module, a compression module, an encoding module, and a processing module.

The detection module is used for acquiring transmission condition data. The decoding module is used for decoding the first GOP and converting it into a first color space. The compression module is used for eliminating similar frames or keeping dissimilar frames and converting the first color space into a second color space according to the transmission condition data. The encoding module converts the second color space into a second GOP according to the transmission condition data. The processing module is electrically connected to the detection module, decoding module, compression module, and encoding module. The processing module is used for controlling the detection module, decoding module, compression module, and encoding module, whereby the sender can transmit the second group of pictures with the reduced bit stream in accordance with the transmission condition data to the receiver.

In one embodiment of the present invention, the detection module connects the sender and the receiver in a peer-to-peer manner and acquires the transmission condition data.

In order to achieve the above object, the electronic device of the present invention is able to transmit multimedia data to a receiver via a network. The multimedia data comprises a first GOP, and the first GOP comprises a plurality of frames. The electronic device comprises a system for reducing the bit stream. The system for reducing the bit stream comprises a detection module, a decoding module, a compression module, an encoding module, and a processing module.

The detection module is used for acquiring transmission condition data. The decoding module is used for decoding the first GOP and converting it into a first color space. The compression module is used for eliminating similar frames and converting the first color space into a second color space according to the transmission condition data. The encoding module converts the second color space into a second GOP according to the transmission condition data. The processing module is electrically connected to the detection module, decoding module, compression module, and the encoding module. The processing module is used for controlling the detection module, decoding module, compression module, and encoding module, whereby the electronic device can transmit the second group of pictures with the reduced bit stream in accordance with the transmission condition data to the receiver.

In one embodiment of the present invention, the detection module connects the electronic device and the receiver in a peer-to-peer manner and acquires the transmission condition data.

### BRIEF DESCRIPTION OF THE DRAWINGS

FIG. 1 presents a diagram of the structure of an electronic device and a system for reducing the bit stream thereof in accordance with one embodiment of the present invention.

FIG. 2 illustrates a flowchart of a method for reducing the bit stream in accordance with one embodiment of the present invention.

### DETAILED DESCRIPTION OF THE PREFERRED EMBODIMENT

The advantages and innovative features of the invention will become more apparent from the following detailed description when taken in conjunction with the accompanying drawings.

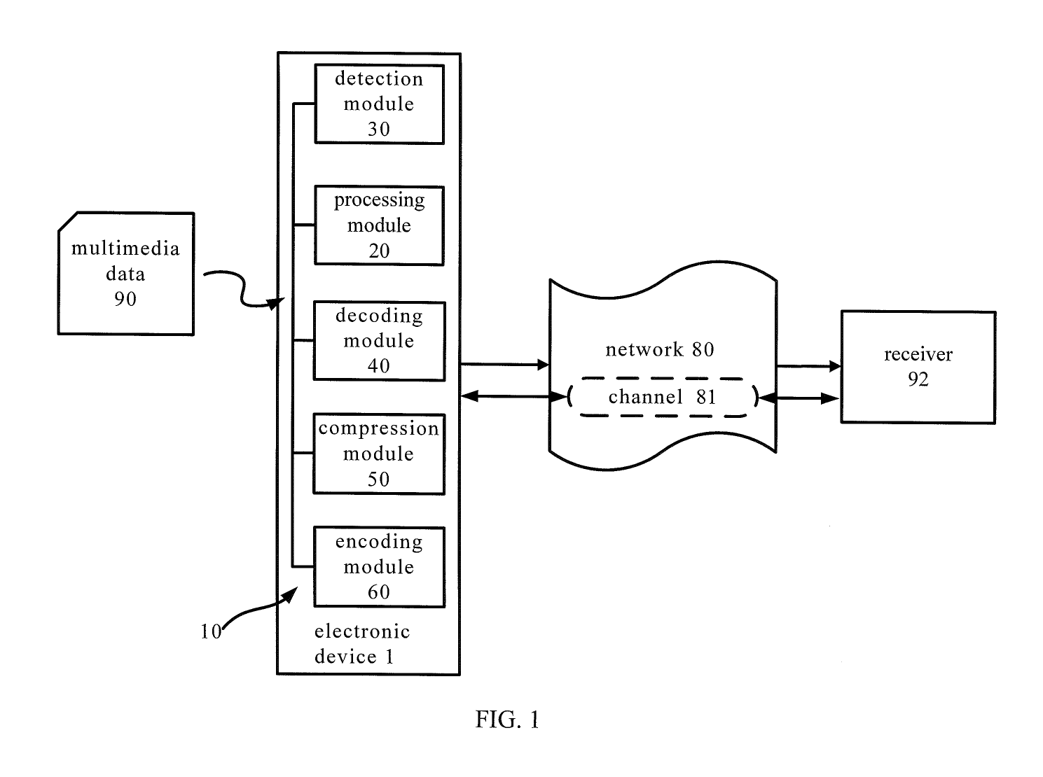

First, for the following description, please refer to FIG. 1. FIG. 1 presents a diagram of the structure of an electronic device and a system for reducing the bit stream thereof in accordance with one embodiment of the present invention.

As shown in FIG. 1, electronic device 1 of the present invention is a sender, capable of transmitting multimedia data 90 to the receiver 91 via a network 80. The multimedia data 90 comprises a first GOP (Group of pictures), and the first GOP comprises a plurality of frames. Electronic device 1 comprises a system for reducing the bit stream 10, wherein the system for reducing the bit stream 10 comprises a detection module 30, a decoding module 40, a compression module 50, an encoding module 60, and a processing module 20. The aforementioned modules are electrically connected to each other.

In one embodiment of the present invention, the processing module 20, detection module 30, decoding module 40, compression module 50, and encoding module 60 may be software programs, hardware devices, firmware, or a combination thereof. Each of the aforementioned modules can be separate or combined with others; however, the present invention is not limited thereto. For example, the decoding module 40 and the encoding module 60 can be merged into one module.

In one embodiment of the present invention, the electronic device 1 can establish a channel 81 between itself and the receiver 92 via the network 80 in a peer-to-peer manner so that a transmission condition data can be acquired.

Next, a method for reducing the bit stream with the system for reducing the bit stream 10 of the present invention is described.

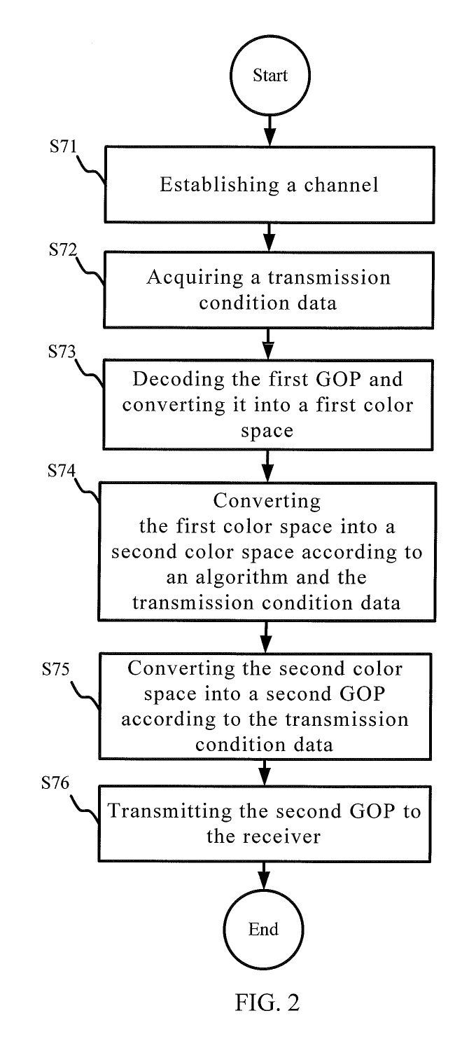

For the following description, please refer to FIG. 1 and FIG. 2 for the illustration of the method for reducing the bit stream in accordance with one embodiment of the present invention. FIG. 2 illustrates a flowchart of the method for reducing the bit stream in accordance with one embodiment of the present invention.

The system for reducing the bit stream 10 of the present invention is used for transmitting the multimedia data 90. The multimedia data 90 are transmitted from electronic device 1 to receiver 92 via network 80. In one embodiment of the present invention, the multimedia data 90 comprise video data or real-time streaming data; however, the present invention is not limited thereto. For example, any video file (e.g. AVI, MPEG, WMV, MOV, or 3GP files) can comprise the multimedia data 90 of the present invention. The multimedia data 90 can be gained from the electronic device 1 or another external device (not shown in figures); however, the present invention is not limited thereto. It should be noted that in one embodiment of the present invention, the electronic device 1 is the sender.

In one embodiment of the present invention, the network 80 can be ADSL, broadband CABLE, Optical Fiber, WiMAX, GPRS, 3G, 3.5G, or Wi-Fi (Wireless Fidelity), etc.; however, the present invention is not limited thereto. It should be noted that in one embodiment of the present invention, the electronic device 1 and the receiver 92 can be in different network environments (not shown in figures).

As shown in FIG. 2, the present invention performs step S71 first: establishing a channel.

In one embodiment of the present invention, the electronic device 1 establishes a channel 81 between itself and a receiver 92 via a network 80 in a peer-to-peer manner.

In one embodiment of the present invention, the electronic device 1 or receiver 92 can be a computer, a notebook computer, a server, a mobile phone, a personal digital assistant (PDA), a game console, a digital camera, or a set-top box (STB); however, the present invention is not limited thereto.

Next, the present invention performs step S72: acquiring a transmission condition data.

In one embodiment of the present invention, the detection module 30 acquires transmission condition data via the channel 81. The transmission condition data comprises the frame rate, the receiving bit rate, the display resolution of receiver 92, the file format supported by receiver 92, or the bandwidth condition of network 80; however, the present invention is not limited thereto.

Next, the present invention performs step S73: decoding the first GOP and converting the first GOP into a first color space.

In one embodiment of the present invention, each frame is one of the following picture types: I-picture (intra picture), P-picture (predictive picture), and B-picture (bi-predictive picture). When the multimedia data 90 is transmitted, a set of I-pictures, P-pictures, and B-pictures is transmitted. Because the relation between a GOP and the multimedia data 90 is well known to those of reasonable skill in the art, the detailed description is omitted.

In one embodiment of the present invention, a decoding module 40 is used for decoding the first GOP and converting the first GOP into a first color space. In one embodiment of the present invention, the first color space is defined by Y values, U values, and V values, which represent the luminance, chrominance, and chroma, respectively, of each frame. Because the relation between a color space and a GOP is well known to those of reasonable skill in the art, the detailed description is omitted.

Next, the present invention performs step S74: converting the first color space into a second color space according to an algorithm and the transmission condition data.

In one embodiment of the present invention, the compression module 50 compares the plurality of frames according to an algorithm and eliminates similar frames, and converts the first color space into a second color space according to the transmission condition data; however, the present invention is not limited thereto. For example, the compression module 50 can compare the plurality of frames and keep dissimilar frames according to another algorithm and then eliminate similar frames and convert the first color space into the second color space according to the transmission condition data. In one preferred embodiment of the present invention, the compression module 50 converts the first color space into the second color space according to the frame rate of receiver 92 and the network bandwidth condition.

More specifically, the compression module 50 eliminates similar frames according to the algorithm so that the bit stream of multimedia data 90 is reduced. Moreover, if the frame rate of the receiver 92 and the network bandwidth condition are lower, the compression module 50 can go through a compression process for the first color space and then convert it into the second color space, so as to reduce the bit stream of the multimedia data 90.

For example, if originally the frame rate of the multimedia data 90 is 30 fps (frame per second), and the frame rate of the receiver 92 is 15 ftp, the compression module 50 will reduce the frame rate of the multimedia data 90. For another example, if the network bandwidth condition of the receiver 92 is low (such as GPRS), the compression module 50 can reduce the Y, U, and V values of each frame, so as to reduce the bit stream and increase the transmission speed. This leads to a reduced upload bandwidth consumed by the sender, leading to a reduced load on the network.

Next, the present invention performs step S75: converting the second color space into a second GOP according to the transmission condition data.

In one embodiment of the present invention, the encoding module 60 converts the second color space into a second GOP according to the transmission condition data. In one preferred embodiment of the present invention, the encoding module 60 converts the second color space into a second GOP according to the receiving bit rate and the display resolution of the receiver 92 and the file format supported by the receiver 92.

More specifically, if the receiving bit rate and the display resolution of the receiver 92 are lower, the encoding module 60 can conduct a compression process (such as reducing the bit rate of the multimedia data 90) and convert the second color space into the second GOP when encoding the second color space, so as to reduce the bit stream of the multimedia data 90.

For example, if the screen size of the receiver 92 is 3.5 inches (for example, the receiver 92 is a mobile phone) with a display resolution of 320*240, the encoding module 60 can reduce the display resolution of the second GOP to 320*240 during the encoding process.

Last, the present invention performs step S76: transmitting the second GOP to the receiver.

In one embodiment of the present invention, the electronic device 1 can directly transmit the second GOP to the receiver 92 via the network 80. The second GOP is the multimedia data 90 with the reduced bit stream in accordance with the transmission condition data.

In one embodiment of the present invention, the electronic device 1 can actively perform the method for reducing the bit stream of the present invention for transmitting the multimedia data 90 to the receiver 92. The method for reducing the bit stream of the present invention can also be performed when the receiver 92 requests the multimedia data 90 from the electronic device 1; however, the present invention is not limited thereto. It should be noted that the method for reducing the bit stream, the system for reducing the bit stream, and the electronic device of the present invention can encode the multimedia data 90 and convert it into data in accordance with the transmission condition data and the playing capability of the receiver 92 in real time and transmit it to the receiver 92.

In another embodiment of the present invention, the electronic device can also transmit multimedia data via a server (not shown in figures) to the receiver. Because the electronic device has already reduced the bit stream, the transmission time of the multimedia data can be greatly reduced and a waste of network resources can be prevented.

It should be noted that the method for reducing the bit stream, the system for reducing the bit stream, and the electronic device of the present invention support without limitation the real-time conversion mechanism “on-the-fly” during the encoding and decoding processes.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A method for reducing the bit stream used when transmitting a multimedia data from a sender to a receiver via a network, wherein the multimedia data comprises a first group of pictures, the method for reducing the bit stream comprising the following steps:
acquiring transmission condition data;
decoding the first group of pictures and converting the first group of pictures into a first color space;
converting the first color space into a second color space according to the transmission condition data; and
converting the second color space into a second group of pictures according to the transmission condition data,
whereby the sender can transmit the second group of pictures with the reduced bit stream in accordance with the transmission condition data to the receiver.

2. The method for reducing the bit stream as claimed in claim 1 further comprises the following step:
converting the first color space into the second color space according to an algorithm and the transmission condition data.

3. The method for reducing the bit stream as claimed in claim 2, wherein the first group of pictures comprises a plurality of frames, and the algorithm compares the plurality of frames and eliminates similar frames or keeps dissimilar frames.

4. The method for reducing the bit stream as claimed in claim 3, the method for reducing the bit stream further comprising the following step prior to the step of acquiring the transmission condition data of the receiver:
establishing a channel connecting the sender and the receiver in a peer-to-peer manner.

5. The method for reducing the bit stream as claimed in claim 4, wherein the transmission condition data comprises a frame rate of the receiver, a receiving bit rate of the receiver, a display resolution of the receiver, a file format supported by the receiver, or a network bandwidth condition.

6. The method for reducing the bit stream as claimed in claim 5 further comprising the following steps:
converting the first color space into the second color space according to the algorithm, the frame rate of the receiver, and the network bandwidth condition; and
converting the second color space into a second group of pictures according to the receiving bit rate of the receiver, the display resolution of the receiver, and the file format supported by the receiver.

7. The method for reducing the bit stream as claimed in claim 6 further comprising the following steps:
transmitting the multimedia data to the receiver.

8. The method for reducing the bit stream as claimed in claim 1, wherein the multimedia data is video data or real-time streaming data.

9. The method for reducing the bit stream as claimed in claim 1, wherein the receiver is a computer, a notebook computer, a server, a mobile phone, a personal digital assistant, a game console, a digital camera, or a set-top box.

10. The method for reducing the bit stream as claimed in claim 1, wherein the sender is a computer, a notebook computer, a server, a mobile phone, a personal digital assistant, a game console, a digital camera, or a set-top box.

11. A system for reducing the bit stream used for transmitting multimedia data, the multimedia data being transmitted from a sender to a receiver via a network, wherein the multimedia data comprises a first group of pictures, and the first group of pictures comprises a plurality of frames, the system for reducing the bit stream comprising:
a detection module for acquiring transmission condition data;
a decoding module for decoding the first group of pictures and converting the first group of pictures into a first color space;
a compression module for eliminating similar frames or keeping dissimilar frames and converting the first color space into a second color space according to the transmission condition data;
an encoding module for converting the second color space into a second group of pictures according to the transmission condition data; and
a processing module electrically connected to the detection module, the decoding module, the compression module, and the encoding module, the processing module being used for controlling the detection module, the decoding module, the compression module, and the encoding module;
whereby the sender can transmit the second group of pictures with the reduced bit stream in accordance with the transmission condition data to the receiver.

12. The system for reducing the bit stream as claimed in claim 11, wherein the detection module connects the sender and the receiver in a peer-to-peer manner and acquires the transmission condition data.

13. The system for reducing the bit stream as claimed in claim 12, wherein the transmission condition data comprises a frame rate of the receiver, a receiving bit rate of the receiver, a display resolution of the receiver, a file format supported by the receiver, or a network bandwidth condition.

14. The system for reducing the bit stream as claimed in claim 11, wherein the multimedia data is video data or real-time streaming data.

15. The system for reducing the bit stream as claimed in claim 11, wherein the receiver is a computer, a notebook computer, a server, a mobile phone, a personal digital assistant, a game console, a digital camera, or a set-top box.

16. The system for reducing the bit stream as claimed in claim 11, wherein the sender is a computer, a notebook computer, a server, a mobile phone, a personal digital assistant, a game console, a digital camera, or a set-top box.

17. An electronic device able to transmit multimedia data to a receiver via a network, wherein the multimedia data comprises a first group of pictures, and the first group of pictures comprises a plurality of frames, the electronic device comprising:
a system for reducing the bit stream, the system for reducing the bit stream comprising:
a detection module for acquiring transmission condition data;
a decoding module for decoding the first group of pictures and converting the first group of pictures into a first color space;
a compression module for eliminating similar frames or keeping dissimilar frames and converting the first color space into a second color space according to the transmission condition data;
an encoding module converting the second color space into a second group of pictures according to the transmission condition data; and
a processing module electrically connected to the detection module, the decoding module, the compression module, and the encoding module, the processing module being used for controlling the detection module, the decoding module, the compression module, and the encoding module;
whereby the electronic device can transmit the second group of pictures with the reduced bit stream in accordance with the transmission condition data to the receiver.

18. The electronic device as claimed in claim 17, wherein the detection module connects the electronic device and the receiver in a peer-to-peer manner and acquires the transmission condition data.

19. The electronic device as claimed in claim 18, wherein the transmission condition data comprises a frame rate of the receiver, a receiving bit rate of the receiver, a display resolution of the receiver, a file format supported by the receiver, or a network bandwidth condition.

20. The electronic device as claimed in claim 17, wherein the electronic device is a computer, a notebook computer, a server, a mobile phone, a personal digital assistant, a game console, a digital camera, or a set-top box.
